(19) United States
(12) Patent Application Publication
(10) Pub. No.: US 2025/0046052 A1
(43) Pub. Date: Feb. 6, 2025

(54) IMAGE RECOGNITION DEVICE AND IMAGE RECOGNITION METHOD

(71) Applicant: JVCKENWOOD Corporation, Yokohama-shi (JP)

(72) Inventor: Takuya OGURA, Yokohama-shi (JP)

(21) Appl. No.: 18/925,111

(22) Filed: Oct. 24, 2024

Related U.S. Application Data
(63) Continuation of application No. PCT/JP2023/013908, filed on Apr. 4, 2023.

(30) Foreign Application Priority Data
Jun. 22, 2022 (JP) 2022-100235

(51) Int. Cl. G06V 10/26; G06V 10/22; G06V 10/776; G06V 20/20

(52) U.S. Cl. CPC G06V 10/273; G06V 10/225; G06V 10/776; G06V 20/20

(57) ABSTRACT

An image recognition device includes: an image acquisition unit that acquires a captured image; a first detection unit that detects a first region including a detection target in the captured image using a first detection model trained by machine learning with an image having an image size of a predetermined value or more as input; a second detection unit that detects a second region including the detection target in the captured image using a second detection model trained by machine learning with an image having an image size of less than the predetermined value as input; and a determination unit that invalidates detection of either one of the first region and the second region when the first region and the second region overlap in the captured image.

### BACKGROUND

### 1. Technical Field

The present disclosure relates to an image recognition device and an image recognition method.

### 2. Description of the Related Art

There are known techniques for detecting objects such as pedestrians from images taken of the surroundings of a vehicle using image recognition techniques such as pattern matching. For example, a technique has been proposed that improves detection accuracy by preparing multiple recognition dictionaries, including one for a far area and one for a nearby area, and performing pattern matching using the multiple recognition dictionaries (see, for example, Patent Literature 1).
[Patent Literature 1] Japanese Patent Application Publication No. 2022-17871

In the above-mentioned prior art, a part of a detection target present in a nearby area may be detected as a detection target by a recognition dictionary for a distant area, and the detection target may not be detected properly.

### SUMMARY

The present disclosure has been made in view of the aforementioned problems, and a general purpose thereof is to provide a technology for improving the detection accuracy of detection targets in an image recognition process based on a recognition dictionary.

An image recognition device according to one embodiment of the present disclosure includes: an image acquisition unit that acquires a captured image; a first detection unit that detects a first region including a detection target in the captured image using a first detection model trained by machine learning with an image having an image size of a predetermined value or more as input; a second detection unit that detects a second region including the detection target in the captured image using a second detection model trained by machine learning with an image having an image size of less than the predetermined value as input; and a determination unit that invalidates detection of either one of the first region and the second region when the first region and the second region overlap in the captured image.

Another embodiment of the present disclosure relates to an image recognition method. This method includes: acquiring a captured image; detecting a first region including a detection target in the captured image using a first detection model trained by machine learning with an image having an image size of a predetermined value or more as input; detecting a second region including the detection target in the captured image using a second detection model trained by machine learning with an image having an image size of less than the predetermined value as input; and invalidating detection of either one of the first region and the second region when the first region and the second region overlap in the captured image.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram schematically showing a functional configuration of an image recognition device according to the first embodiment.

FIGS. 2A, 2B, 2C and 2D are diagrams showing examples of images for learning.

FIG. 3 is a diagram showing an example of a captured image in which first and second regions are detected without overlapping.

FIG. 4 is a diagram showing an example of a captured image in which first and second regions are detected while overlapping.

FIG. 5 is a diagram showing an example of an image for display in which additional images are superimposed.

FIG. 6 is a diagram showing an example of an image for display in which an additional image is superimposed.

FIG. 7 is a flowchart showing the flow of an image recognition method according to the first embodiment.

FIG. 8 is a block diagram schematically showing a functional configuration of an image recognition device according to the second embodiment.

FIG. 9 is a diagram showing an example of a captured image in which a first region, a second region, and a part region are detected while overlapping.

FIG. 10 is a flowchart showing the flow of an image recognition method according to the second embodiment.

### DETAILED DESCRIPTION

The invention will now be described by reference to the preferred embodiments. This does not intend to limit the scope of the present invention, but to exemplify the invention.

Described below is an explanation of the embodiments of the present disclosure with reference to figures. Specific numerical values and the like shown in the embodiments are shown merely for illustrative purposes to facilitate understanding of the invention and do not intend to limit the scope of the present disclosure, unless otherwise noted. In the figures, elements not directly related to the present disclosure are omitted from the illustration.

### First Embodiment

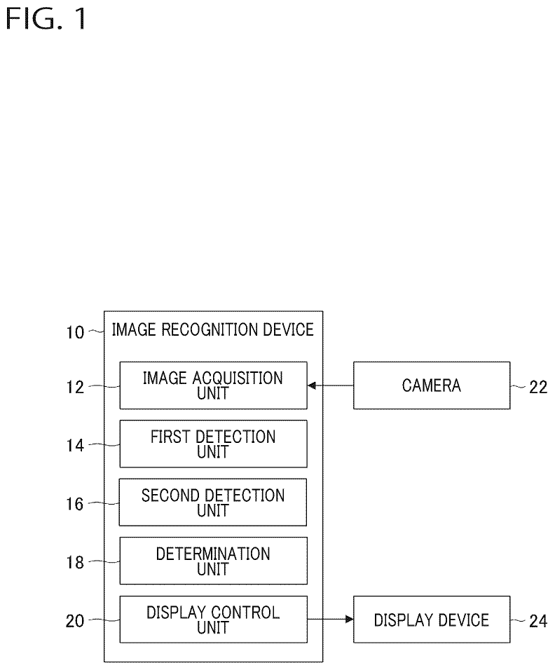

FIG. 1 is a block diagram schematically showing a functional configuration of an image recognition device 10 according to the first embodiment. The image recognition device 10 includes an image acquisition unit 12, a first detection unit 14, a second detection unit 16, a determination unit 18, and a display control unit 20. The image recognition device 10 is mounted on a moving object, such as a vehicle, for example, so as to detect pedestrians and the like around the vehicle. The image recognition device 10 may be fixedly installed in a predetermined location so as to detect people and the like around the device. In the present embodiment, a case in which the image recognition device 10 is mounted on a vehicle is shown as an example. Further, a case in which the image recognition device 10 detects a person such as a pedestrian is also shown as an example in the present embodiment. As detection targets detected by the image recognition device 10, objects other than people are also applicable.

The functional blocks shown in the present embodiment can be realized, for example, by cooperation between hardware and software. The hardware of the image recognition device 10 is realized by elements such as a CPU or memory of a computer or by mechanical devices. The software of the image recognition device 10 is realized by a computer program, etc.

The image acquisition unit 12 acquires a captured image taken by the camera 22. The camera 22 is mounted on a vehicle and captures images of the surroundings of the vehicle. For example, the camera 22 captures images of an area in front of the vehicle. The camera 22 may also capture images of an area behind the vehicle or an area on the side of the vehicle. The image recognition device 10 may or may not be equipped with the camera 22.

The camera 22 is configured to capture infrared rays around the vehicle. The camera 22 is a so-called infrared thermography camera, which provides an image of the temperature distribution around the vehicle, making it possible to identify heat sources present around the vehicle. The camera 22 may be configured to detect mid infrared rays with a wavelength of around 2 μm to 5 μm or may be configured to detect far infrared rays with a wavelength of around 8 μm to 14 μm. The camera 22 may be configured to image visible light. The camera 22 may be configured to image red, green and blue color images or may be configured to image monochrome images of visible light. In the present embodiment, the camera 22 is described as a camera that captures thermal images using far infrared light. Captured images taken by the camera 22 are, for example, moving images captured at 30 frames per second or so.

The first detection unit 14 detects a first region including a detection target in a captured image acquired by the image acquisition unit 12. The first detection unit 14 detects the detection target using a first detection model trained by machine learning with an image having an image size of a predetermined value or more as input. The first detection model is a recognition dictionary for a nearby area for detecting a detection target that exists in the nearby area. When the detection target is a pedestrian, an example of the size of the input image used for the machine learning for the first detection model is 160 pixels in height and 80 pixels in width.

The second detection unit 16 detects a second region including a detection target in a captured image acquired by the image acquisition unit 12. The second detection unit 16 detects the detection target using a second detection model trained by machine learning with an image having an image size of less than the predetermined value as input. The second detection model is a recognition dictionary for a distant area for detecting a detection target that exists in the distant area. The size of an input image used for machine learning for the second detection model is smaller than the size of an input image used for machine learning for the first detection model. When the detection target is a pedestrian, an example of the size of the input image used for the machine learning for the second detection model is 80 pixels in height and 40 pixels in width.

A model used for machine learning can include input that corresponds to the image size (number of pixels) of an input image, output that outputs a recognition score, and an intermediate layer that connects the input and the output. The intermediate layer can include a convolutional layer, a pooling layer, a fully-connected layer, etc. The intermediate layer may have a multi-layered structure and may be configured to allow so-called deep learning to be performed. The model used for machine learning may be constructed using a convolutional neural network (CNN). The model used for machine learning is not limited to those described above, and any machine learning model may be used.

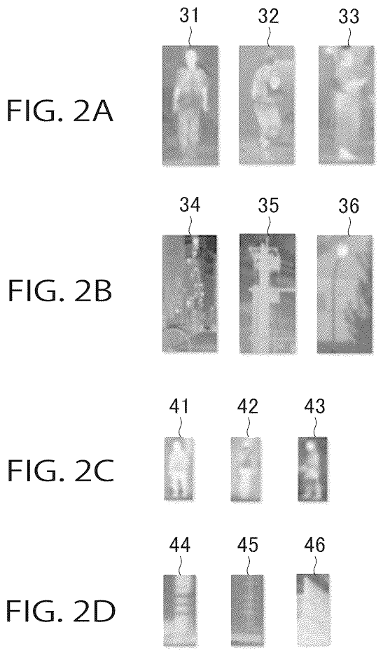

FIGS. 2A, 2B, 2C and 2D are diagrams showing examples of images for learning and show examples of images for learning that are used to generate a detection model for pedestrians. FIGS. 2A and 2B show images 31-36 for learning for generating the first detection model. FIGS. 2C and 2D show images 41-46 for learning for generating the second detection model. FIGS. 2A and 2C are examples of correct data, and FIGS. 2B and 2D are examples of incorrect data.

As shown in the figures, the images 31-36 for learning for the first detection model are relatively large in image size and have relatively high resolution. An example of the image size of the images 31-36 for learning for the first detection model is 160 pixels by 80 pixels. On the other hand, images 41-46 for learning for the second detection model have a relatively small image size and a relatively low resolution. An example of the image size of the images 41-46 for learning for the second detection model is 80 pixels by 40 pixels.

The determination unit 18 determines the validity of the detection results obtained by the first detection unit 14 and the second detection unit 16. When a region including a detection target is detected by the first detection unit 14 or the second detection unit 16 without the overlapping of the first region and the second region, the determination unit 18 determines the detection to be valid. The determination unit 18 determines the detection of the first region to be valid when the first region is detected by the first detection unit 14 while the second region overlapping the first region is not detected by the second detection unit 16. The determination unit 18 determines the detection of the second region to be valid when the second region is detected by the second detection unit 16 while the first region overlapping the second region is not detected by the first detection unit 14. The determination unit 18 determines that the detection of the first region and the detection of the second region are valid when the first region and the second region do not overlap in a captured image, that is, when the first region and the second region are apart from each other.

When regions including a detection target are detected to overlap each other by both the first detection unit 14 and the second detection unit 16, the determination unit 18 determines the validity of the detection result according to the overlapping of the detected regions in a captured image. The determination unit 18 determines that the detection of one of the first region and the detection of the second region is valid and that the detection of the other region is invalid when the first region and the second region overlap in a captured image, that is, when the detection target of the first region and the detection target of the second region are the same. For example, when the first and second regions overlap in the captured image, the determination unit 18 validates the detection of the first region and invalidates the detection of the second region. The determination unit 18 invalidates the detection of the second region that overlaps the first region in the captured image.

The determination unit 18 may manage list data of a detection region detected by the first detection unit 14 or the second detection unit 16. The determination unit 18 adds the data of the first region detected by the first detection unit 14 to the list. The determination unit 18 adds the data of the second region detected by the second detection unit 16 to the list. When the first and second regions overlap, the determination unit 18 removes the data of the second region that overlaps the first region from the list. In this case, the remaining detection region (the first or second region) in the list becomes valid, and the detection region (the first or second region) removed from the list becomes invalid.

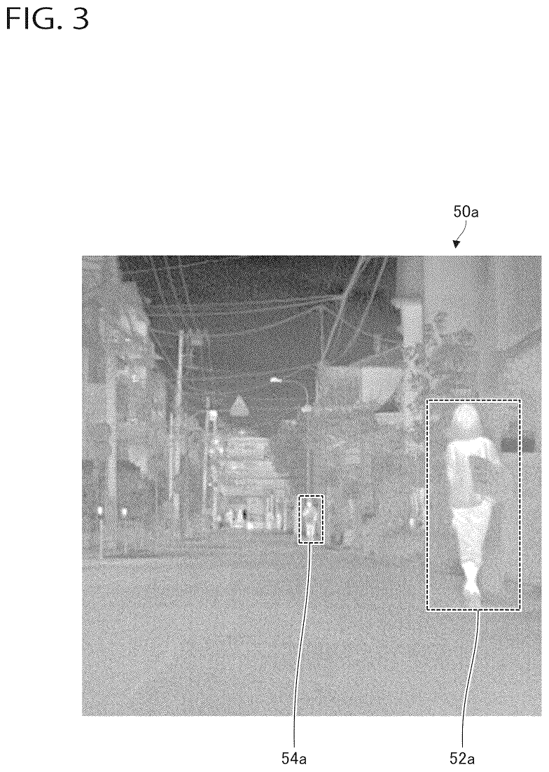

FIG. 3 is a diagram showing an example of a captured image 50a in which first and second regions 52a and 54a are detected without overlapping. The first region 52a detected by the first detection unit 14 includes a pedestrian who appears large in a captured image 50a because he/she is located close to the camera 22. The second region 54a detected by the second detection unit 16 includes a pedestrian who appears small in the captured image 50a because he/she is located close to the camera 22.

In the case of FIG. 3, the determination unit 18 validates the detection of both the first region 52a and the detection of the second region 54a since the first region 52a and the second region 54a do not overlap. This allows for proper detection of pedestrians included in each of the first and second regions 52a and 54a. In other words, both pedestrians located near and far can be properly detected.

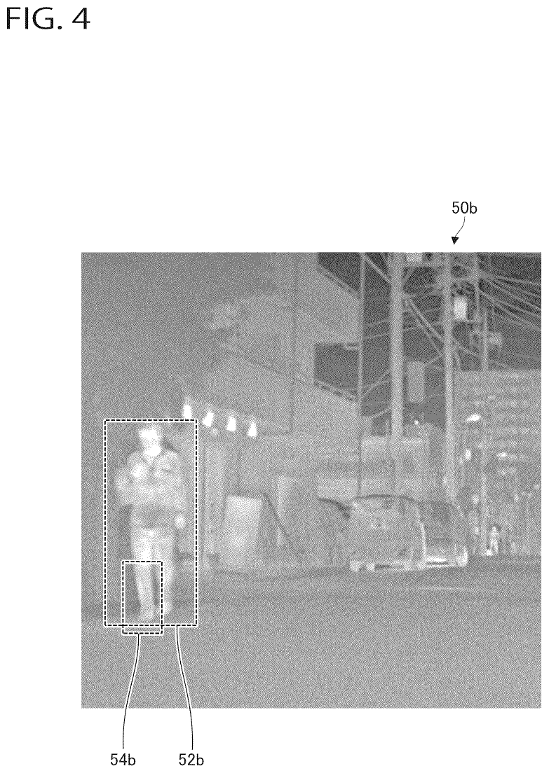

FIG. 4 is a diagram showing an example of a captured image 50b in which first and second regions 52b and 54b are detected while overlapping. The first region 52b detected by the first detection unit 14 includes a pedestrian who appears large in a captured image 50b because he/she is located close to the camera 22. The second region 54b detected by the second detection unit 16 includes the right leg of a pedestrian who is located close to the camera 22. In the case of FIG. 4, the second detection unit 16 wrongly detects the part of the pedestrian located nearby as the second region 54b. Such false detection can occur because the image size of the partial range of the pedestrian located nearby is close to the detection size of the second detection model for a distant area, and the luminance distribution (e.g., heat distribution) of that partial range approximates that of the second detection model.

In the case of FIG. 4, the determination unit 18 validates the detection of the first region 52b while invalidating the detection of the second region 54b since the first region 52b and the second region 54b overlap. This allows false detection made by the second detection unit 16 to be invalidated and the pedestrian included in the first region 52b to be properly detected.

Returning to FIG. 1, the display control unit 20 generates an image for display based on the determination result from the determination unit 18 and displays the generated image for display on the display device 24. The display control unit 20 generates an image for display in which an additional image, such as a frame image for indicating a region validated by the determination unit 18, has been superimposed on the captured image. The display control unit 20 generates the image for display in which the additional image has been superimposed such that the display mode of a region that has not been invalidated by the determination unit 18 and the display mode of a region that has been invalided are different from each other. For example, the display control unit 20 does not superimpose the additional image in the region invalidated by the determination unit 18. The display control unit 20 may superimpose a first additional image such as a red frame in a region not invalidated by the determination unit 18, i.e., a valid region, and superimpose a second additional image whose display mode is different from that of the first additional image such as a green frame in a region invalidated by the determination unit 18.

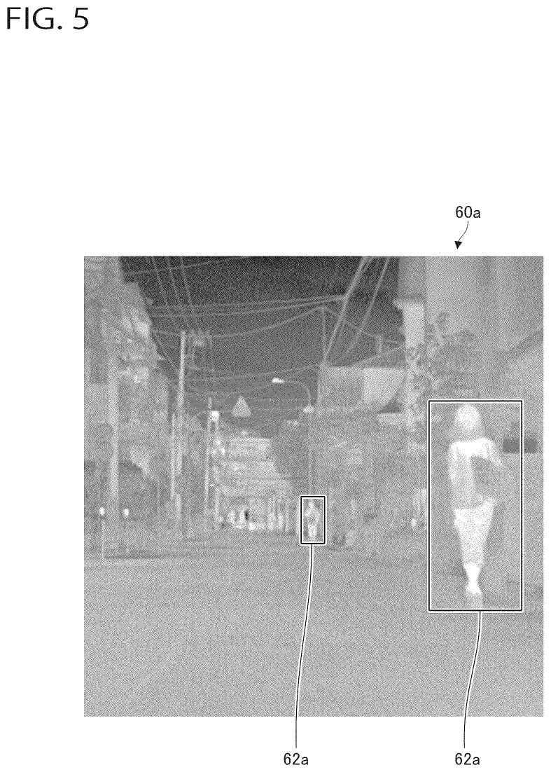

FIG. 5 is a diagram showing an example of an image 60a for display in which additional images 62a are superimposed. The image 60a for display in FIG. 5 is displayed on the display device 24 when the captured image 50a in FIG. 3 is acquired. The additional images 62a are superimposed on the respective positions corresponding to the first region 52a and the second region 54a (see FIG. 3) that have not been invalidated by the determination unit 18. By superimposing the additional images 62a, the detection target can be displayed in an emphasized manner.

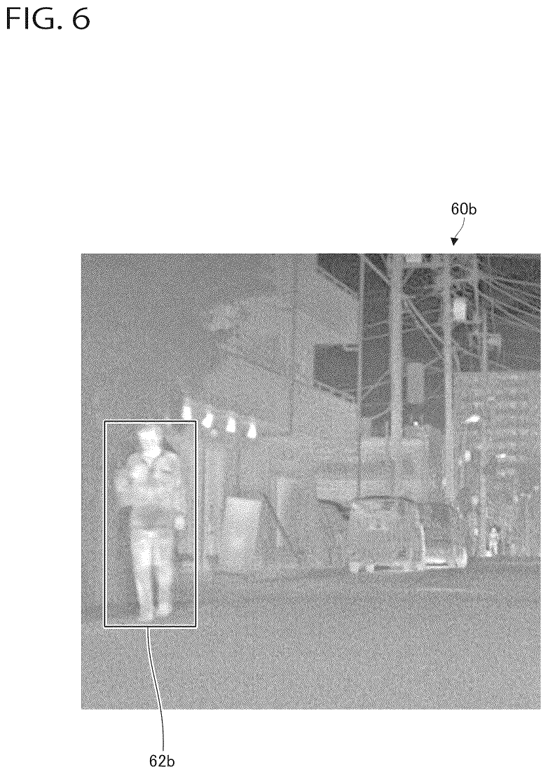

FIG. 6 is a diagram showing an example of an image 60b for display in which an additional image 62b is superimposed. The image 60b for display in FIG. 6 is displayed on the display device 24 when the captured image 50b in FIG. 4 is acquired. The additional image 62b is superimposed at a position corresponding to the first region 52b (see FIG. 4) that has not been invalidated by the determination unit 18, but is not superimposed at a position corresponding to the second region 54b (see FIG. 4) that has been invalidated by the determination unit 18. By superimposing the additional image 62b, the detection target can be displayed in an emphasized manner. By not superimposing the additional image in the second region 54b, which is false detection, it is possible to prevent erroneous information from being conveyed to the user.

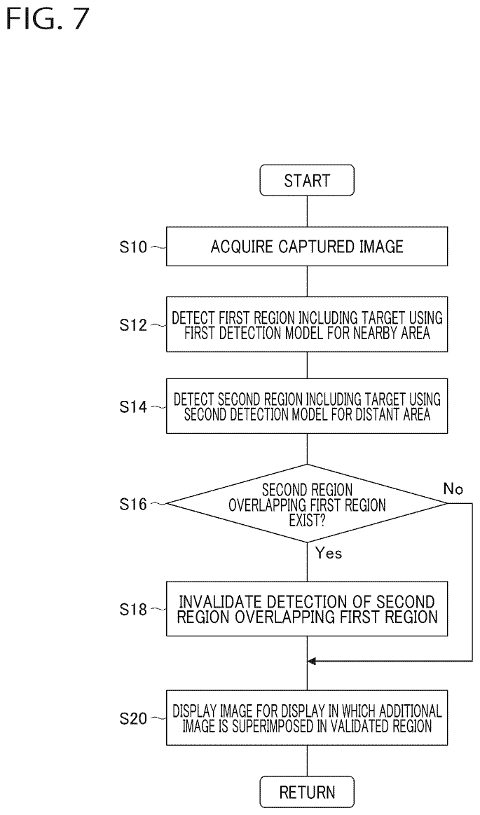

FIG. 7 is a flowchart showing the flow of an image recognition method according to the first embodiment. The flowchart shown in FIG. 7 is repeatedly executed while the image recognition device 10 is in operation or while image-capturing is being performed by the camera 22. The image acquisition unit 12 acquires a captured image (Step S10). The first detection unit 14 detects a first region that includes a detection target in the captured image using the first detection model for a nearby area (Step S12). The second detection unit 16 detects a second region that includes a detection target in the captured image using the second detection model for a distant area (Step S14).

When the first and second regions overlap in the captured image (Yes at Step S16), the determination unit 18 invalidates detection of the second region overlapping the first region (Step S18). More specifically, when the first and second regions are detected in the captured image and the range of the detected first region overlaps the range of the detected second region, the detection of the second region overlapping the first region is invalidated. For example, the determination unit 18 may determine that the second region overlaps the first region when 90% or more of the area of the detected second region overlaps the detected first region.

When the first region and the second region do not overlap in the captured image (No at Step S16), the determination unit 18 skips the process in Step S18. When the first and second regions overlap, the determination unit 18 validates the detection of the first region and invalidates the detection of the second region. The determination unit 18 validates the detection of regions other than the second region to be invalidated. When the first and second regions do not overlap, the determination unit 18 validates the detection of the detected first and second regions. The display control unit 20 generates an image for display in which an additional image is superimposed in a region to be validated and displays the image for display on the display device 24 (Step S20). The display control unit 20 displays the image for display in which the additional image is superimposed for a period during which the region to be validated is being detected.

According to the present embodiment, when the first region that is detected by the first detection unit 14 and the second region that is detected by the second detection unit 16 overlap, false detection can be prevented by invalidating one of the regions. Since the second detection model for a distant area uses an image for learning whose resolution is lower than that of the first detection model for a nearby area, the possibility of false detection is relatively high. According to the present embodiment, by prioritizing the first region detected by the first detection model for a nearby area, the second region that overlaps the first region and is falsely detected can be invalidated. This can increase the detection accuracy of detection targets.

### Second Embodiment

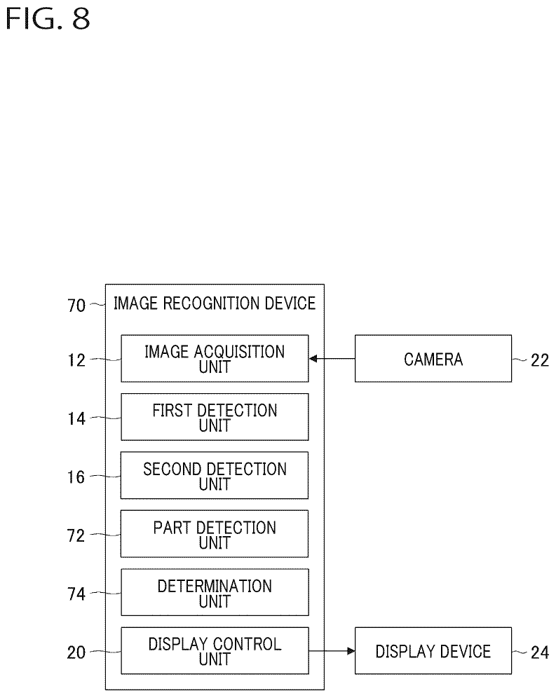

FIG. 8 is a block diagram schematically showing a functional configuration of an image recognition device 70 according to the second embodiment. The second embodiment differs from the first embodiment in that a part detection unit 72 is further provided and that the determination unit 74 determines the validity of detection using detection results from the part detection unit 72. The second embodiment will be explained mainly on the differences from the first embodiment in the following, and explanations on common features will be omitted.

The image recognition device 70 includes an image acquisition unit 12, a first detection unit 14, a second detection unit 16, a part detection unit 72, a determination unit 74, and a display control unit 20. The image acquisition unit 12, the first detection unit 14, the second detection unit 16, and the display control unit 20 are configured in the same manner as in the first embodiment.

The part detection unit 72 detects a part region including parts of a detection target in a captured image acquired by the image acquisition unit 12. The part detection unit 72 detects a part of the detection target using a part detection model trained by machine learning with an image of a partial range of the detection target as input. For example, a partially cropped image of the detection target included in the image for learning of the first detection model for a nearby area can be used as an image for learning for the part detection model. Therefore, the image size of the image for learning for the part detection model is smaller than the size of an input image used for machine learning for the first detection model. The image size of the image for learning for the part detection model may be about the same size as that of an input image used for machine learning for the second detection model.

The part detection unit 72 may have a plurality of part detection models for detecting a plurality of parts of a detection target, respectively. For example, if the detection target is a pedestrian, the part detection unit 72 may have part detection models for detecting the head, the upper body, the lower body, the arms, and the legs, respectively.

The part detection unit 72 detects parts of the detection target included in the first region detected by the first detection unit 14. When a part of the detection target is detected in the first region, detection by the first detection unit 14 is considered appropriate since there is a high possibility that the entire detection target is included in the first region. On the other hand, when no part of the detection target is detected in the first region, since there is a high possibility that the entire detection target is not included in the first region, detection by the first detection unit 14 is considered inappropriate, and the first detection unit 14 is considered to be making false detection.

When the first or second region is detected without overlapping, the determination unit 74 validates the detection. When both the first and second regions are detected and the first and second regions overlap in a captured image, the determination unit 74 determines the validity of the detection of the first region and the detection of the second region using the detection results from the part detection unit 72.

When the first and second regions overlap in the captured image and a part region overlaps the first region, the determination unit 74 validates the detection of the first region and invalidates the detection of the second region. In this case, it is highly likely that the part of the detection target included in the first region is detected as the second region, and the second detection unit 16 is highly likely to be making false detection. When the first and second regions overlap in the captured image and the part region does not overlap the first region, the determination unit 74 invalidates the detection of the first region and validates the detection of the second region. In this case, it is less likely that the entire part of the detection target is included in the first region, and the first detection unit 14 is highly likely to be making false detection.

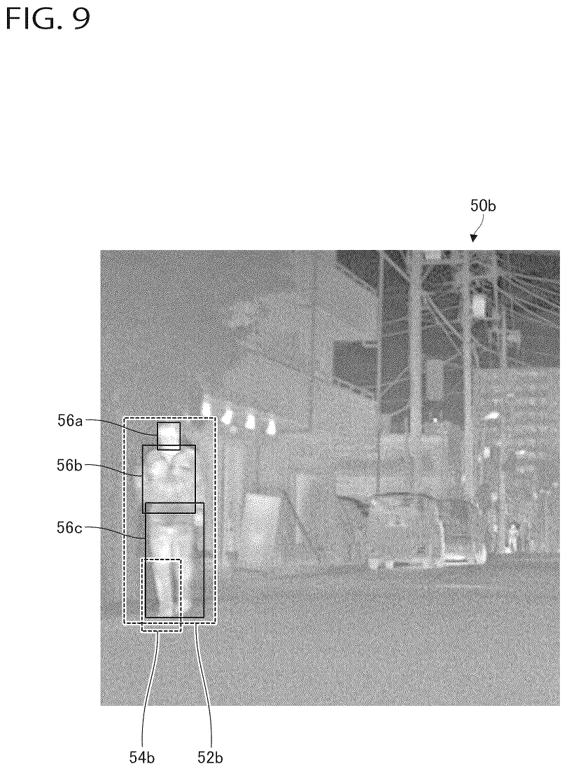

FIG. 9 is a diagram showing an example of a captured image 50b in which a first region 52b, a second region 54b, and part regions 56a, 56b, and 56c are detected while overlapping. The captured image 50b in FIG. 9 is the same as that in FIG. 4. However, the captured image 50b is different in that the first part region 56a, the second part region 56b, and the third part region 56c are detected by the part detection unit 72. The first part region 56a is a detected region of the pedestrian's head included in the first region 52b. The second part region 56b is a detection region of the upper body of a pedestrian included in the first region 52b. The third part region 56c is a detection region of the lower body of the pedestrian included in the first region 52b.

In the case of FIG. 9, the determination unit 74 validates the detection of the first region 52b while invalidating the detection of the second region 54b since the first region 52b and the second region 54b overlap and the first region 52b and the part regions 56a to 56c overlap. This allows false detection made by the second detection unit 16 to be invalidated and the pedestrian included in the first region 52b to be properly detected. When the display control unit 20 acquires the captured image 50b in FIG. 9, the display control unit 20 displays the image 60b for display just like that in FIG. 6 on the display device 24.

In FIG. 9, a state is shown where the first region 52b and part regions 56a-56c overlap. However, the detection of the first region 52b may be validated, and the detection of the second region 54b may be invalidated due to the overlapping of any of the first part region 56a, the second part region 56b, and the third part region 56c on the first region 52b.

In FIG. 9, for example, the detection of the first region 52b may be validated, and the detection of the second region 54b may be invalidated when the first part region 56a, in which the head is detected, overlaps an upper part of the first region 52b. Further, in FIG. 9, the detection of the first region 52b may be validated, and the detection of the second region 54b may be invalidated when the second part region 56b, in which the upper body is detected, overlaps an upper part of the first region 52b. Further, in FIG. 9, the detection of the first region 52b may be validated, and the detection of the second region 54b may be invalidated when the third part region 56c, in which the lower body is detected, overlaps a lower part of the first region 52b. Even when detection is performed using a different part detection model, the detection of the first region 52b may be validated, and the detection of the second region 54b may be invalidated when a part region overlap at an appropriate location in a range where a pedestrian is detected.

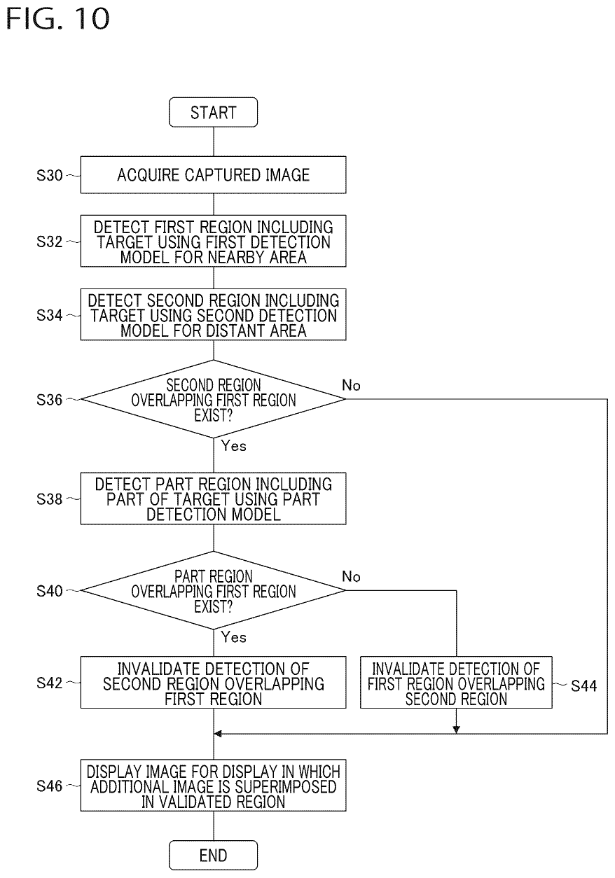

FIG. 10 is a flowchart showing the flow of an image recognition method according to the second embodiment. Processes from Step S30 to Step S36 and processes in Step S42 and Step S46 in the flowchart shown in FIG. 10 are identical to the processes from Step S10 to Step S16 and the processes in Step S18 and Step S20 in the flowchart shown in FIG. 7, and the explanation thereof is thus omitted.

If the first and second regions overlap in a captured image (Yes at Step S36), the part detection unit 72 detects a part region that includes a part of a detection target in the first region using a part detection model (Step S38). When there is a part region that overlaps the first region (Yes at Step S40), the determination unit 74 invalidates detection of the second region overlapping the first region (Step S42). When there is no part region that overlaps the first region (No at Step S40), the determination unit 74 invalidates detection of the first region overlapping the second region (Step S44). When the first region and the second region do not overlap in the captured image (No at Step S36), the processes in Step S38 to S44 are skipped.

According to the present embodiment, when the first and second regions overlap, detection of the presence or absence of a part of a detection target in the first region allows for more appropriate determination of the effectiveness of the detection in the first region. When a part of the detection target is detected in the first region, the detection in the first region is validated, and the detection in the second region is invalidated, thereby allowing for invalidation of the second region that overlaps the first region and is falsely detected. On the other hand, when no part of the detection target is detected in the first region, the detection in the second region is validated, and the detection in the first region is invalidated, thereby allowing for invalidation of the first region that overlaps the second region and is falsely detected. This can increase the detection accuracy of detection targets.

In the second embodiment, when the first and second regions overlap, the determination unit 74 may validate detection in the first region if multiple part regions are detected in the first region. For example, the detection in the first region may be validated when any two or more part regions for the head, the upper body, the lower body, the arms, and the legs are detected.

While the present disclosure has been described by referring to the above-described embodiments, the present disclosure is not limited to the above-described embodiments, and those resulting from any combination of the configurations shown in the embodiments or substitution thereof are also within the scope of the present disclosure.

What is claimed is:

1. An image recognition device comprising:
an image acquisition unit that acquires a captured image;
a first detection unit that detects a first region including a detection target in the captured image using a first detection model trained by machine learning with an image having an image size of a predetermined value or more as input;
a second detection unit that detects a second region including the detection target in the captured image using a second detection model trained by machine learning with an image having an image size of less than the predetermined value as input; and
a determination unit that invalidates detection of either one of the first region and the second region when the first region and the second region overlap in the captured image.

2. The image recognition device according to claim 1,
wherein the first detection model is a recognition dictionary for a nearby area and the second detection model is a recognition dictionary for a distant area, and
wherein the size of an image used for machine learning for the second detection model is smaller than the size of an image used for machine learning for the first detection model.

3. The image recognition device according to claim 1, wherein the determination unit invalidates the detection of the second region when the first region and the second region overlap in the captured image.

4. The image recognition device according to claim 1, further comprising:
a part detection unit that detects a part region including a part of the detection target using a part detection model trained by machine learning,
wherein the determination unit is configured to:
a) invalidate the detection of the second region when the first region and the second region overlap in the captured image and the first region and the part region overlap; and
b) invalidate the detection of the first region when the first region and the second region overlap in the captured image and the first region and the part region do not overlap.

5. The image recognition device according to claim 1, further comprising a display control unit that displays an image for display in which an additional image is superimposed on the captured image such that the display mode of the first or second region not invalidated by the determination unit is different from the display mode of the first or second region invalidated by the determination unit.

6. An image recognition method comprising:
acquiring a captured image;
detecting a first region including a detection target in the captured image using a first detection model trained by machine learning with an image having an image size of a predetermined value or more as input;
detecting a second region including the detection target in the captured image using a second detection model trained by machine learning with an image having an image size of less than the predetermined value as input; and
invalidating detection of either one of the first region and the second region when the first region and the second region overlap in the captured image.
